(19) United States
(12) Patent Application Publication
(10) Pub. No.: US 2013/0111336 A1
(43) Pub. Date: May 2, 2013

(54) PLATFORM AND APPLICATION INDEPENDENT SYSTEM AND METHOD FOR NETWORKED FILE ACCESS AND EDITING

(71) Applicants: Griffin Dorman, Los Altos, CA (US); Brandon Savage, Los Altos, CA (US); Arnold Goldberg, Los Gatos, CA (US)

(72) Inventors: Griffin Dorman, Los Altos, CA (US); Brandon Savage, Los Altos, CA (US); Arnold Goldberg, Los Gatos, CA (US)

(21) Appl. No.: 13/332,319

(22) Filed: Dec. 20, 2011

Related U.S. Application Data
(60) Provisional application No. 61/554,450, filed on Nov. 1, 2011.

(51) Int. Cl. G06F 17/00; G06F 15/16

(52) U.S. Cl. 715/255

(57) ABSTRACT

Platform and application independent system and method for networked file access and/or editing are disclosed. In one aspect, embodiments of the present disclosure include a method, which may be implemented on a system, for identifying an application locally available for use on the device, to edit the file via an operating system of a device through which the request is initiated and automatically launching the application on the device or passing an identifier of the file to the application, such that the file is opened and thus available for edit using the application without a prior prompt to store the file on the device. The automatic launching of the application can occur without the prior prompt to request a user to specify a local directory in which to store the file.

### CROSS REFERENCE TO RELATED APPLICATIONS

This application claims the benefit of U.S. Provisional Patent Application No. 61/554,450 entitled “Platform and Application Independent System and Method for Document Editing and Version Tracking via a Web Browser,” which was filed on Nov. 1, 2011, the contents of which are incorporated by reference herein.

### BACKGROUND

As electronic or digital content is used in enterprise settings or other organizations as the preferred mechanism for project, task, and work flow management, as has the need and use of streamlined collaboration and editing surrounding digital content and documents. As multiple users are sharing and accessing content and files in the shared work space, downloading and editing processes and mechanisms become a regularly accessed feature and is an integral component of the user's perception of system performance and ease of use.

However, due to the nature of collaboration-based services or platforms, where content or work items include the work contributed or provided by multiple users typically using different applications and devices with different platforms (e.g., different OS or desktop/mobile platforms/devices), oftentimes editing or viewing the files created or edited by others may be challenging or onerous due to incompatibilities in file types and the applications different users prefer to use and/or are available on a given device used or available to a user to access/edit a shared file.

### BRIEF DESCRIPTION OF THE DRAWINGS

FIG. 1 illustrates an example diagram of a system having a host server able to facilitate application and/or platform independent networked editing or accessing of files stored thereon by a client device.

FIG. 2 depicts an example diagram of a web-based or online collaboration platform deployed in an enterprise or other organizational setting for organizing work items and workspaces.

FIG. 3 depicts an example diagram of a workspace in an online or web-based collaboration environment accessible by multiple collaborators through various devices.

FIG. 4 depicts a block diagram illustrating an example system in which work items or files hosted by the host server of a collaboration environment can be edited or accessed remotely by devices independent of the platform or locally available applications.

FIG. 5 depicts a block diagram illustrating an example of components in a host server for facilitating platform and/or application independent editing or accessing of work items over a network.

FIG. 6 depicts a block diagram illustrating an example of components on the client side on a user device for enabling platform and/or application independent editing or accessing of work items on the user device over a network from a host server.

FIG. 7A depicts a flow chart illustrating an example process for networked file editing and version tracking independent of the platform or application on the device used for to access the file.

FIG. 7B depicts a flow chart illustrating examples of platform independent processes for selecting an application on a device for accessing a file.

FIG. 8 depicts a flow chart illustrating example platform independent processes for managing file access in a collaboration environment and platform/application independent file editing/access at a user device.

FIG. 9 depicts a flow chart illustrating example process for implementing version tracking and control in response to a request to open or access a file/work item via a collaboration platform.

FIG. 10 depicts a flow chart illustrating example process for downloading a file or work item onto a user device for platform or application independent for access or editing that is independent of the device platform or the applications locally available to the user device.

FIG. 11-12 depicts flow charts illustrating example processes for uploading or sending a file/work item that has been remotely edited to a host server from which the file was accessed or downloaded.

FIG. 13 depicts a screenshot showing an example of a user interface illustrating processes for uploading or sending a file/work item that has been remotely edited to a host server from which the file was accessed or downloaded.

FIG. 14 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for platform or application-independent access and edit of networked files/work items.

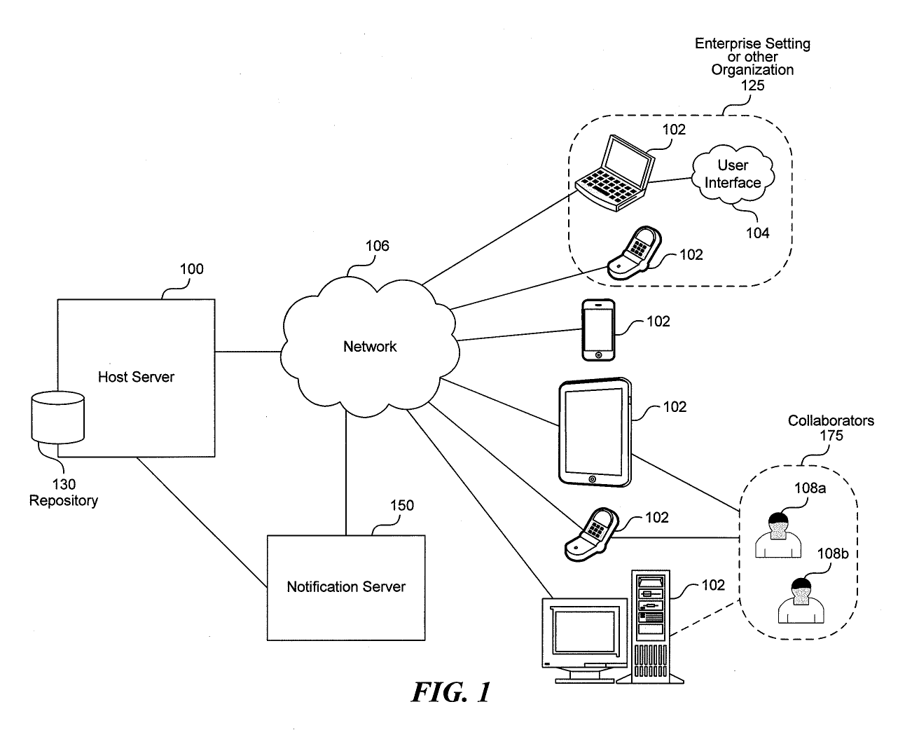

FIG. 1 illustrates an example diagram of a system having a host server 100 able to facilitate application and/or platform independent networked editing or accessing of files stored thereon by client devices 102.

The client devices 102 can be any system and/or device, and/or any combination of devices/systems that is able to establish a connection, including wired, wireless, cellular connections with another device, a server and/or other systems such as host server 100 and/or notification server 150. Client devices 102 will typically include a display and/or other output functionalities to present information and data exchanged between among the devices 102 and/or the host server 100 and/or notification server 150.

For example, the client devices 102 can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, and/or any other portable, mobile, hand held devices, etc. running on any platform or any operating system (e.g., Mac-based OS (OS X, iOS, etc.), Windows-based OS (Windows Mobile, Windows 7, etc.), Android, Blackberry OS, Embedded Linux platforms, Palm OS, Symbian platform. In one embodiment, the client devices 102, host server 100, and app server 110 are coupled via a network 106 and/or a network 108. In some embodiments, the devices 102 and host server 100 may be directly connected to one another.

The input mechanism on client devices 102 can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

Signals received or detected indicating user activity at client devices 102 through one or more of the above input mechanism, or others, can be used in the disclosed technology by various users or collaborators (e.g., collaborators 108) for accessing, through network 106, a web-based collaboration environment or online collaboration platform (e.g., hosted by the host server 100).

The collaboration platform or environment hosts workspaces with work items that one or more users can access (e.g., view, edit, update, revise, comment, download, preview, tag, or otherwise manipulate, etc.). A work item can generally include any type of digital or electronic content that can be viewed or accessed via an electronic device (e.g., device 102). The digital content can include .pdf files, .doc, slides (e.g., Powerpoint slides), images, audio files, multimedia content, web pages, blogs, etc. A workspace can generally refer to any grouping of a set of digital content in the collaboration platform. The grouping can be created, identified, or specified by a user or through other means. This user may be a creator user or administrative user, for example.

In general, a workspace can be associated with a set of users or collaborators (e.g., collaborators 108) which have access to the content included therein. The levels of access (e.g., based on permissions or rules) of each user or collaborator to access the content in a given workspace may be the same or may vary among the users. Each user may have their own set of access rights to every piece of content in the workspace, or each user may be different access rights to different pieces of content. Access rights may be specified by a user associated with a work space and/or a user who created/uploaded a particular piece of content to the workspace, or any other designated user or collaborator.

In general, the collaboration platform allows multiple users or collaborators to access or collaborate efforts on work items such each user can see, remotely, edits, revisions, comments, or annotations being made to specific work items through their own user devices. For example, a user can upload a document to a work space for other users to access (e.g., for viewing, editing, commenting, signing-off, or otherwise manipulating). The user can login to the online platform and upload the document (or any other type of work item) to an existing work space or to a new work space. The document can be shared with existing users or collaborators in a work space.

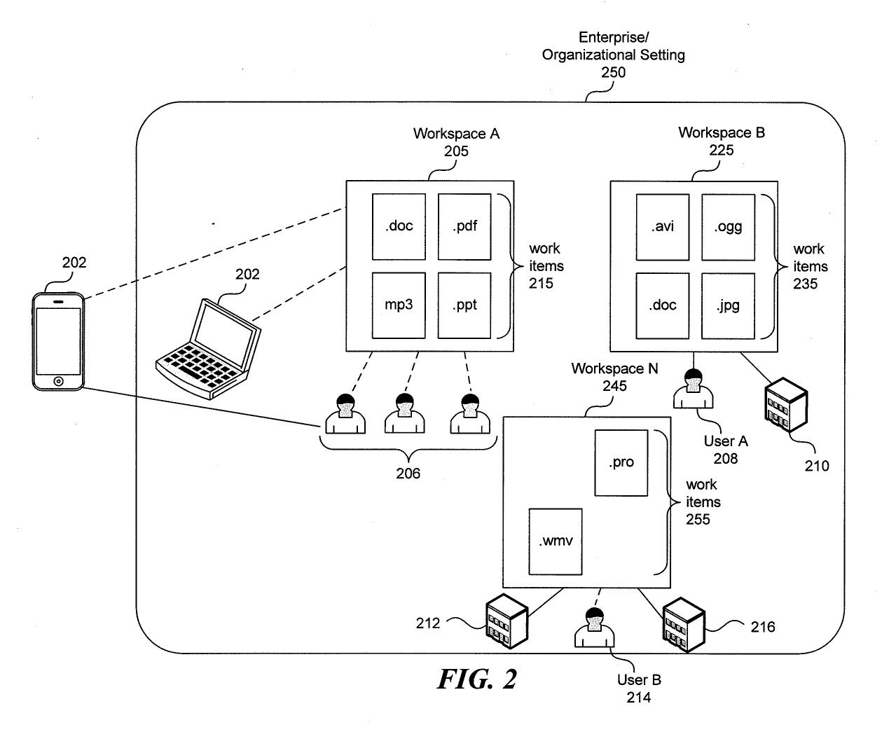

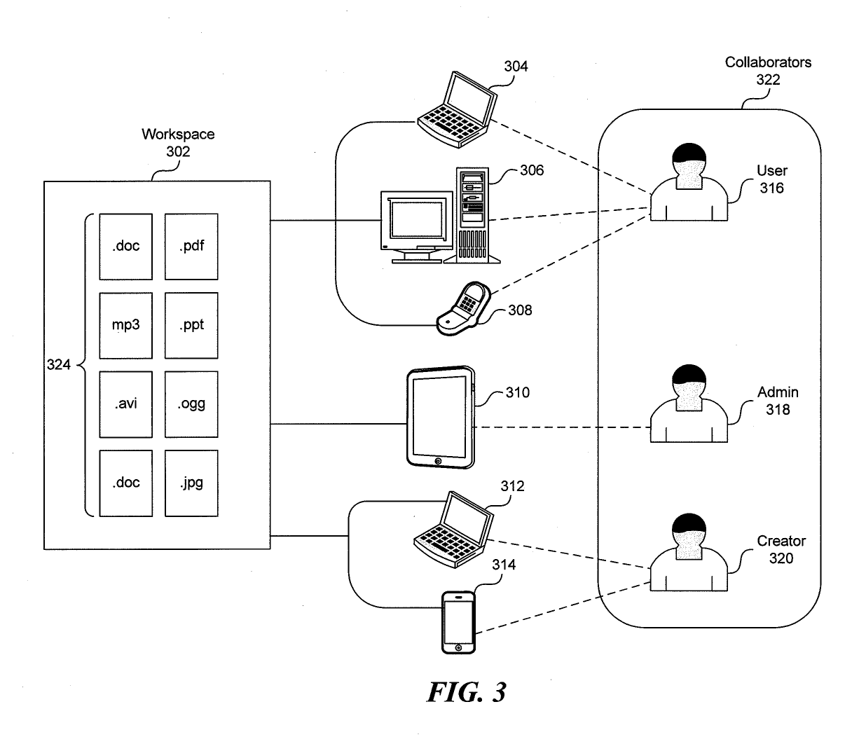

A diagrammatic illustration of the online collaboration environment and the relationships between workspaces and users/collaborators are illustrated with further reference to the example of FIG. 2. A diagrammatic illustration of a workspace having multiple work items with which collaborators can access through multiple devices is illustrated with further reference to the example of FIG. 3.

In one embodiment, the host server 100 of the online or web-based collaboration environment provides platform and application independent methods and features for networked file access and editing by a remote device (e.g., by user devices 102). Specifically, the host server 100 and components residing on a client side (e.g., on a user device 102) enables a user to edit files or other work items on the host server 100 using their own choice of applications, or any application that is available on the device 102 they are using to access/edit the file, and regardless of the device 102 platform (e.g., mobile, or desktop or operating system).

Furthermore, the user can edit the file accessed from the host server 100 without the additional process of manually downloading and storing the file locally on the device 102. For example, the file may be ready for the user to edit locally without informing that the file is stored or prompting the user for a directory in which to store the file, to streamline the access/edit process to enhance user experience.

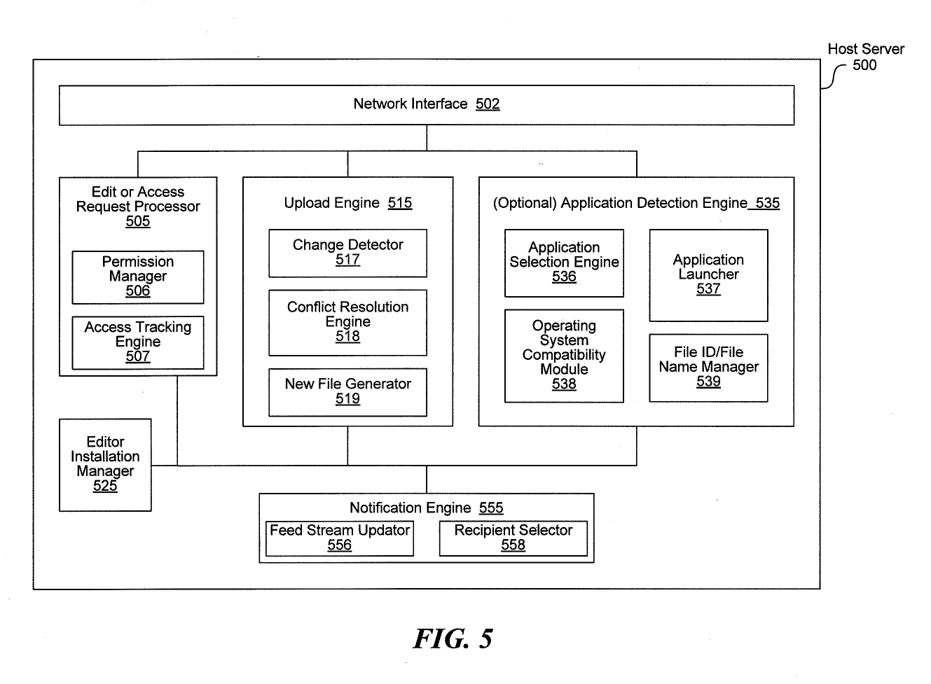

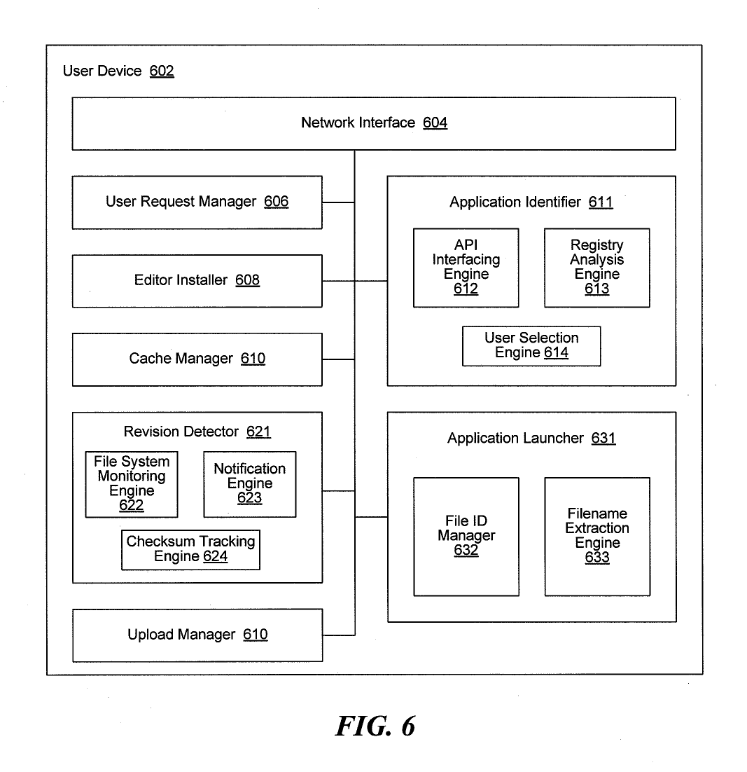

Functions and techniques disclosed for platform and/or application independent file access/editing are further described with reference to the components illustrated in the example of FIG. 5-6. Functions and techniques performed by the host server 100, the client side components on a device 102, and other related components therein are described, respectively, in detail with further reference to the examples of FIG. 5-12.

In one embodiment, client devices 102 communicate with the host server 100 and/or notification server 150 over network 106. In general, network 106, over which the client devices 102, the host server 100, and/or notification server 150 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102 and the host server 100 and may appear as one or more networks to the serviced systems and devices. In one embodiment, communications to and from the client devices 102 can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

FIG. 2 depicts an example diagram of a web-based or online collaboration platform deployed in an enterprise or other organizational setting 250 for organizing work items 215, 235, 255 and workspaces 205, 225, 245.

The web-based platform for collaborating on projects or jointly working on documents can be used by individual users and shared among collaborators. In addition, the collaboration platform can be deployed in an organized setting including but not limited to, a company (e.g., an enterprise setting), a department in a company, an academic institution, a department in an academic institution, a class or course setting, or any other types of organizations or organized setting.

When deployed in a organizational setting, multiple workspaces (e.g., workspace A, B C) can be created to support different projects or a variety of work flows. Each workspace can have its own associate work items. For example, work space A 205 may be associated with work items 215, work space B 225 can be associated with work items 235, and work space N can be associated with work items 255. The work items 215, 235, and 255 may be unique to each work space but need not be. For example, a particular word document can be associated with only one work space (e.g., work space A 205) or it may be associated with multiple work spaces (e.g., Work space A 205 and work space B 225, etc.).

In general, each work space has a set of users or collaborators associated with it. For example, work space A 205 is associated with multiple users or collaborators 206. In some instances, work spaces deployed in an enterprise may be department specific. For example, work space B may be associated with department 210 and some users shown as example user A 208 and workspace N 245 can be associated with departments 212 and 216 and users shown as example user B 214.

Each user associated with a work space can generally access the work items associated with the work space. The level of access will depend on permissions associated with the specific work space, and/or with a specific work item. Permissions can be set for the work space or set individually on a per work item basis. For example, the creator of a work space (e.g., one of user A 208 who creates work space B) can set one permission setting applicable to all work items 235 for other associated users and/or users associated with the affiliate department 210, for example. Creator user A 208 may also set different permission settings for each work item, which may be the same for different users, or varying for different users.

In each work space A, B . . . N, when an action is performed on a work item by a given user or any other activity is detected in the work space, other users in the same work space may be notified (e.g., in real time or in near real time, or not in real time). Activities which trigger real time notifications can include, by way of example but not limitation, adding, deleting, or modifying collaborators in the work space, uploading, downloading, adding, deleting a work item in the work space, creating a discussion topic in the work space.

Specifically, items or content downloaded or edited in accordance with the techniques described in the present disclosure can be cause notifications to be generated. Such notifications can be sent to relevant users to notify them of actions surrounding a download, an edit, a change, a modification, a new file, a conflicting version, an upload of an edited or modified file.

FIG. 3 depicts an example diagram of a workspace 302 in an online or web-based collaboration environment accessible by multiple collaborators 322 through various devices.

Each of users 316, 318, and 320 can individually use multiple different devices to access and/or manipulate work items 324 in the work space 302 with which they are associated with. For example users 316, 318, 320 can be collaborators on a project to which work items 324 are relevant. Since the work items 324 are hosted by the collaboration environment (e.g., a cloud-based environment), each user can access the work items 324 anytime, and from any physical location using any device (e.g., including devices they own or any shared/public/loaner device).

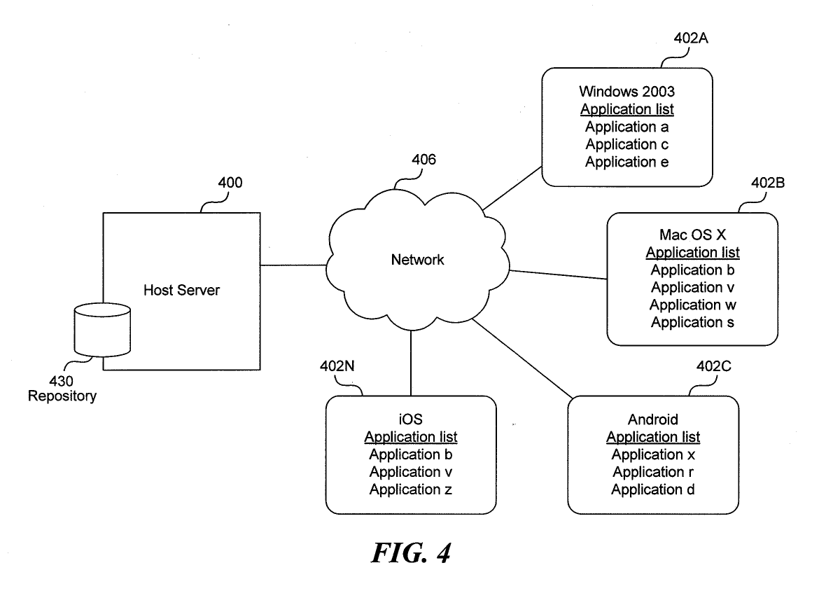

Work items to be edited or viewed can be accessed from the workspace 302 in accordance with the platform and/or application independent mechanisms disclosed herein, as further described with references to the examples of FIG. 4-13. Users can also be notified of access, edit, modification, and/or upload related-actions performed on work items 324 by other users or any other types of activities detected in the work space 302. For example, if user 316 modifies a document, one or both of the other collaborators 318 and 320 can be notified of the modification in real time, or near real-time, or not in real time. The notifications can be sent through any of all of the devices associated with a given user, in various formats including, one or more of, email, SMS, or via a pop-up window in a user interface in which the user uses to access the collaboration platform. In the event of multiple notifications, each notification can be depicted preferentially (e.g., ordering in the user interface) based on user preferences and/or relevance to the user (e.g., implicit or explicit).

For example, a notification of a download, access, read, write, edit, or uploaded related activities can be presented in a feed stream among other notifications through a user interface on the user device according to relevancy to the user determined based on current or recent activity of the user in the web-based collaboration environment.

FIG. 4 depicts a block diagram illustrating an example system in which work items or files hosted by the host server 400 of a collaboration environment can be edited or accessed remotely by devices 402 (402A-N) independent of the platform or locally available applications.

For example, any given file initially stored on the host server 400 (e.g., in the repository 430) can be edited using any of the devices 402A-N, despite the differing platforms and operating systems. Furthermore, any given file stored on the host 400 can be edited or accessed using any device 402A-N, as long as each individual device has an application which can open/edit the file type of the requested file.

In general, the process of identifying a local application suitable for accessing a file requested from the host server 400 is streamlined and automatic, and can be performed without prompting the user. Since the local components on a local device is able to query or monitor the operating system of any of the devices 402A-N to identify one or more suitable applications (e.g., default application or preferred application) for the file type of the requested file. By communicating with the operating system, (e.g., by monitoring the OS through the API, registry, or other methods), the process for detecting a suitable application for each device is operating system (platform)-independent and application-independent, thus working with any of the devices 402A-N and any other types of devices running different operating systems, platforms, and/or having installed thereon different applications.

FIG. 5 depicts a block diagram illustrating an example of components in a host server 500 for facilitating platform and/or application independent editing or accessing of work items over a network.

The host server 500 of the web-based or online collaboration environment can generally be a cloud-based service. The host server 500 can include, for example, a network interface 502, an edit or access request processor 505 having a permission manager 506 and/or an access tracking engine 507, an upload engine 515 having a change detector 517, a conflict resolution engine 518, and/or a new file generator. The host server 500 can further include an application detection engine 535 (an optional component) having in addition, an application selection engine 536, an application launcher 527, an operating system compatibility module 538, and/or a file ID/filename manager 539, for example. One embodiment, of the host server 500 further optionally includes a notification engine 555 having, for example, a feed stream updator 556 and/or a recipient selector 558. Additional or less components/modules/engines can be included in the host server 500 and each illustrated component.

The network interface 502 can be a networking module that enables the host server 500 to mediate data in a network with an entity that is external to the host server 400, through any known and/or convenient communications protocol supported by the host and the external entity. The network interface 502 can include one or more of a network adaptor card, a wireless network interface card (e.g., SMS interface, WiFi interface, interfaces for various generations of mobile communication standards including but not limited to 1G, 2G, 3G, 3.5G, 4G, LTE, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” “a manager,” a “handler,” a “detector,” an “interface,” a “processor,” a “tracker,” a “detector,” a “generator,” a “launcher,” a “selector,” an “updator,” or an “engine” includes a general purpose, dedicated or shared processor and, typically, firmware or software modules that are executed by the processor. Depending upon implementation-specific or other considerations, the module, manager, hander, or engine can be centralized or its functionality distributed. The module, manager, hander, or engine can include general or special purpose hardware, firmware, or software embodied in a computer-readable (storage) medium for execution by the processor. As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

One embodiment of the host server 500 includes the edit or access request processor 405 which can receive, detect, process, identify, parse, translate, and/or determine a request from a user or user device to view, edit, modify, read, or otherwise access a file stored on, managed by, or otherwise hosted by the host system 500. The request can be submitted from a user (e.g., through a user interface) to edit or view one or more files or work items stored on the host 500 (e.g., a host of a web-based or online collaboration platform).

The user can identify the files, content, or items to be accessed via the host server 500 one-by-one and queue up multiple items (e.g., including but not limited to files, folders, documents, images, audio, videos, or other media/multimedia content, etc.) to be accessed, viewed, or edited in a single request. The user can also select one or more of the items to be accessed, and detected or managed by the edit/access request process 505. Using a drop down box or other user interface features in the web interface of the host server 500, e.g., via a button such as an ‘edit’ or ‘download’, or ‘request’ button in the user interface. In some instances, the ‘edit’ button may be disabled for selection when the file is locked (e.g., in use by another user) and unavailable for edit or for download to edit as a mechanism for version control. Alternatively, the user may be allowed to edit the file anyways but with a prompt warning that the file is in use and allowing the user to make the decision. In this case, the file may be edited but stored as a different version by the host server 500.

Responsive to detection of the request (e.g., by the edit/access request processor 505), user permission can initially be verified, for example, using the credentials submitted by the user (e.g., by the permission manager 506). The version control mechanisms can be performed for example, by the access tracking engine 507 to implement a process whereby only one user can edit one file at a given time, or implementation of multiple user edits, but using a method to track all edits with procedures in place for conflict resolution (e.g., by maintaining multiple copies either on the host server 500 and/or on respective user devices used by the multiple users).

In one embodiment, the request processor 505, in response to determining that the item at the host server 500 which requested for local access by a user on a user device, is not locked or in use by another user, is enabled for editing on the user device and can be downloaded remotely. The permission manager 506 can, for example, provide a file to a first user for access at a first device of the first user's, using a first application which is available to the first user at the first device and providing the file to a second user for access at a second device of the second user's, using a second application which is available to the second user at the second device.

In general, the first application, used by the first user is identified through a first operating system of the first device, among applications installed on the first device; and the second application, used by the second user, is identified through a second operating system of the second device, among applications installed on the second device. This allows the file to be accessed and/or edited at any user device, regardless of the underlying platform or applications installed thereon.

The permission manager 506 and/or the access tracking engine 507 allows both users and any additional users to edit/access the same file while managing potential conflicts, for example, by timing the edits so that changes from different users can be factored in, and/or keeping multiple versions of the same file and resolving conflicts if applicable. For example, the file can be provided to the first and second users and enabled for editing or access otherwise, at either the first device or the second device when the file is not locked or in use by the other party. In some instances, prior to providing the file to the first and second users, an authentication process is performed to verify or confirm access rights, for example, by the permission manager 506.

In one embodiment, a first and second user request to edit or access the file can be authenticated through credentials provided via a web interface to services hosted by the host server 500. Furthermore, updated versions of the file received from the first and second devices, at the host server in a manner that resolves conflicting changes to the file (e.g., by the conflict resolution engine 518 of the upload engine 515).

The editor installation manager 525 can send any installation files or components to a user device requesting to access or edit a file stored on the host 500. For example, upon receiving a request to access or edit a file, if detected that the user device (e.g., user device 102 or 602 of FIG. 1 and FIG. 6 respectively) does not have the components, the editor installation manager 525 can send the install file to the target device.

One embodiment of the host server 500 optionally includes an application detection engine 535 for identifying and selecting one or more suitable application at a remote user device (e.g., user device 102 or 602 as shown in FIG. 1 or FIG. 6) from which a request to access or edit a file is received. Some or all of the functions performed by the components can be performed at the client side (e.g., at the user device 102 or 602).

In general, the application detection is compatible with any mobile or desktop operating system by being able to detect or identify various APIs for different operating systems/platforms, or registry keys for different operating systems/platforms which enable the host 500 or application detection engine 535 to identify information regarding applications installed at a remote device (e.g., user device). For example, the operating system compatibility module 538 is able to identify an API of the operating system which tracks or maintains, or can be used to identify any preferred or default applications for accessing a given file type.

This allows the process of application identification and selection to be independent of what applications are installed on a requesting user device, and the platform of the user device. The functions performed by the application selection engine 536, the application launcher 537, the file ID/file name manager 539 perform the same similar functions as the corresponding components described for the user device (e.g., user device 602 of FIG. 6), and some or all of the functions may be present in lieu of or in addition to those on the user device 602.

The upload engine 515 can store updated versions of the file received from various users using various devices. Different versions of the same file are stored in a manner that resolves conflicting changes to the file. For example, the change detector 517 detects the different versions of the same file and uses the conflict resolution engine 518 to resolve any conflicting changes (e.g., through merging changes or removing outdated changes). The new file generator 519 can generate or create a new file when there are two or more versions of the same file such that conflicting changes can be preserved until further determination can be made regarding which to be saved.

One embodiment of the host server 500 includes optionally, a notification engine 555. The notification engine 555, can for example, update a feed stream to include an updated feed indicate that an item or multiple items have been downloaded, edited, uploaded, or uploaded with edits/modifications, for example, via the feed stream updator 556. The users that are notified can be selected, for example, by the recipient selector 558, and can include collaborators or the user, or other users meeting a criterion. In some instances, the feed stream is updated in real time or near real time relative to when the upload of the item completed. For real-time updating, the notification engine 555 can utilize another server (e.g., the notification server 150 shown in the example of FIG. 1), or another engine in the same server which provides push functionality, as illustrated in the example of FIG. 1.

The notification engine 555 can generally can users, which can be collaborators of the user who performed the activity in the work space via one or more of many mechanisms, including but not limited to, email, SMS, voice-message, text-based message, RSS, feed, etc., as described in detail with further reference to related co-pending U.S. patent application Ser. No. 13/152,982 filed on Jun. 3, 2011. The contents of which are incorporated herein by reference in its entirety.

In one embodiment, the notification is depicted through a web-browser used by the other user to access the web-based collaboration environment, for access in real time or near real time to when the activity was performed by the user. When notifying a user in real time through a web-browser, the notification engine 415 can utilize a push-enabled service to ensure real time notification. In one embodiment, the notification is sent by a component or another server which implements push technology (e.g., the notification server 500 shown in the example of FIG. 5). The push-enabled service can be implemented via long poll or HTTP streaming, for example, by the notification severs 500 or another component, device which may be internal to or external to the host server 500. In addition, the host server 500 could utilize other push servers including third party push servers to implement push technology including but not limited to mobile platform push systems and services (e.g., via smart phones or tablets or other portable devices such as iPhone, Android phones, Blackberry, iPad, Galaxy or other tablets, etc.)

The notification engine 555 can determine the channel through which to notify selected users or recipients of an access request, a download, a file edit/modification, a file save or upload (e.g., an upload request, completion of upload of a single item, multiple items, and/or a full upload request). The channels that are used can include, indicators via a user interface to the online collaboration environment, SMS, audio message, text-based messages, email, desktop application, RSS, etc.

FIG. 6 depicts a block diagram illustrating an example of components on the client side on a user device 602 for enabling platform and/or application independent editing or accessing of work items on the user device over a network from a host server (e.g., the host server 100 or 500 in the example of FIG. 1 and FIG. 5 respectively).

The user device 602 (e.g., the user device 102 or 402 shown in the examples of FIG. 1 and FIG. 4 respectively) can include, for example, a network interface 604, a user request manager 606, an editor installer 608, a cache manager 610, an application identifier 611 having for example, an API interfacing engine 612 and/or a registry analysis engine 613, a revision detector 621 having a file system monitoring engine 622 and/or a notification engine, an application launcher 631 having a file ID manager and/or a file name extraction engine 633, and/or an upload manager 610. Additional or less components/modules/engines can be included in the user device 602 and each illustrated component.

The network interface 604 can be a networking module that enables the user device 602 to mediate data in a network with an entity that is external to the host server 400, through any known and/or convenient communications protocol supported by the host and the external entity. The network interface 604 can include one or more of a network adaptor card, a wireless network interface card (e.g., SMS interface, WiFi interface, interfaces for various generations of mobile communication standards including but not limited to 1G, 2G, 3G, 3.5G, 4G, LTE, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” “a manager,” a “handler,” a “detector,” an “interface,” a “processor,” a “tracker,” a “detector,” a “generator,” a “launcher,” a “selector,” an “updator,” or an “engine” includes a general purpose, dedicated or shared processor and, typically, firmware or software modules that are executed by the processor. Depending upon implementation-specific or other considerations, the module, manager, hander, or engine can be centralized or its functionality distributed. The module, manager, hander, or engine can include general or special purpose hardware, firmware, or software embodied in a computer-readable (storage) medium for execution by the processor. As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

Note that the components on the user device 602 which enables platform and/or application independent access or editing of files from a host server can be installed (e.g., by the editor installer 608) on the user device 602 or running in an application plug-in or widget (e.g., running in a web browser). The installation can be performed by the editor installer 608 downloaded at user request or downloaded in response to detecting user request to edit or access files or other work items from a remote device (e.g., a host server).

The download and install process may occur and complete with or without user intervention. For example, in some instances, some or all of the components shown in the user device 602 can be automatically downloaded and/or installed upon receiving the user's request. The components can be downloaded/installed in part or in whole, and/or at an as-needed basis. In one embodiment, installed components may be removed automatically when the file has been edited or accessed (e.g., after the file has been closed or uploaded back to the remote device/server).

The user request manager 606 can detect, receive, manage, process, identify any read, access, write, modify, request of a remotely hosted or stored file from a user at the user device 602. The file can be stored or managed by any remote device or server connected with the user device 602 over a network (e.g., via the network interface 604). Detection of the request can cause the components for access/editing the file to be installed, if applicable (e.g., by the editor installer 608). If the components are already installed or where installation is not necessary, the cache manager 610 can determine whether the file is already open on the user device 602. If so, the application which has the file open can be activated or brought to the foreground.

If not, the cache manager 620 can determine whether there is a cached copy of the file stored in a user device 602 cache. If a cached version is determined by the cache manager 620 to be the most recent copy (e.g., more recent than the version stored on the remote device or host server), then the cached version is selected to be the one to be opened for access. If no cached version is available, or if a newer version on the remote device or host server exists, then the newer version can be the one that is made available for access or edit on the user device 602.

One embodiment of the user device 602 components for platform and/or application independent access or editing of files accessed from a remote device or host server includes the application identifier 611. The application identifier 611 can detect, identify, select, activate, one or more of any application available for use at the user device 602 to access or view a file based on file type. For example, the application identifier 611 can interact/communicate with operating system components to identify or detect one or more applications suited for accessing or editing a given file requested for access from the remote host, based on its file type, for example. In one embodiment, If the local device does not have an application to open the requested file, the web page may not show an “Edit” button, or provide an option for the user to download or stream a compatible application for accessing the file type.

The application identifier 611, can for example, obtain the information using an application program interface (API) of the operating system of the user device 602, which can be native to the operating system (e.g., via the API interfacing engine 612). For example, the API interfacing engine 612 can detect or identify a suitable API available on the user device 602 or available to the operating system/platform of the device 602 for detecting or identifying an application to open, access, or edit the requested file.

In one embodiment, the API is native to the operating system (e.g., MAC based OS including OS X, iOS, Android, Windows-based OS including Windows Mobile and desktop platforms). The API can by any interface for launching services which enables one application to open other applications on the device. The API which is used may also provide the ability for an application to open a document or URL in another application, identify or detect a default or preferred application for a given file type or to open a given document or URL, register information in the OS regarding application types and associated file types with which to open a document or file, or detect/extract information used for displaying a file or URL on the display of the device (e.g., icon, display name, kind string, etc.). For example, in MAC OS X, the Launch Services API may be used to identify one or more applications.

In one embodiment, information regarding applications on the user device 602 which can be used to open a specific file type is determined through the registry of the operating system on the device 602. For example, the application can be identified using one or more keys in the registry and the associated key values. For example, in the Windows OS, HKEY_CLASSES_ROOT can be used in the registry to determine which application is associated with a filetype, additional or other keys may also be used in Windows or other operating systems.

The applications identified, for example, based on the file type of a requested file, either using the API or a registry key in the registry, can be the default application or a preferred application used in by the user device 602 operating system to open or access the file, while other applications which can be used to open the file type (e.g., by extracting the file extension from the file name of the requested file) can also be identified, for example as additional options. The application identifier 611 can use the results of the identification to select an application for use in opening the requested file. The selected application can be the default or preferred application as determined through the operating system. The selected application can also be another application which is able to open the file based on its file type but not necessarily the default or preferred application configured in the operating system of the device 602.

In some instances, the application to edit the file is specified by a user at the device (e.g., via the user selection engine 614). The user can manually specify a preferred application for the application identifier 611 to ultimately select the application used to open the file. The user can also explicitly specify the application that is used. Alternatively, the application identifier 611 can identify a list of applications including the default or preferred applications for the file type and present the list of options to the user for selection, when the user request to open a file. In general, the application is identified from a set of applications installed on the device 602 such that the process need not require the user to download specific applications to open the file.

In some instances, the user selection engine 614 tracks and/or manages a set of user preferences for applications to be used for specific file types and automatically makes a selection of an application based on users preferences and/or information extracted from the operating system (e.g., via the API and/or registry keys). For example, a cross comparison between OS-identified applications can be made with user-preferred applications for a file type and a selection can be made therefrom.

In general, the identification of the application to edit the file can occur transparently to a user who generated the request at the device. Specifically, an application may automatically be launched by the application launcher 631. The application can be launched and depicted through the user interface as occurring immediately in response to the request to edit the file, without prompting the user for additional action or depicting additional steps through the user interface.

Thus, the processes performed by the application identifier 611 to identify and select a suitable application to open the file can occur without knowledge to the user that these steps are occurring. In addition, the automatic launching of the application can occur without a prior prompt to store the file, and/or a prompt to prompt a user to specify a local directory in which to store the file. The application can also be launched and the file can be opened, by the application launcher 631 without communicating to the user regarding whether the file is stored on the user device 602 and/or regarding where/how it is stored.

In some instances, the file is opened and available for edit using the application without any intervening steps, except to prompt or to query the user regarding a selection of an application to use. For example, the user may be prompted when an application cannot be automatically identified. The user may be prompted with a list of identified applications which are compatible with the file type of the requested file. Note that prompting of the user to select an application may be a user-configurable setting; specifically, the user can select whether or not they want to be prompted to select an application when requesting to open a file from a remote device or host server.

The application launcher 631 can launch the selected or detected application to open/access the file through the operating system such that the process is application-independent (or compatible with any application). For example, the application can be launched through an application program interface of the operating system. The application launcher 631 can extract the file name of the requested file (e.g., via the filename extraction engine 633) and pass the file name or other file identifier (e.g., as determined or tracked by the file ID manager 632) to the selected or identified application for opening. The file ID manager 632 can also pass the file ID or file name to an application process without launching the application if an instance is already running.

In one embodiment, the filename extraction engine 633 can identify or extract the file extension for use in determining the file type of the file or work item requested at the user device 602 from a remote device or host. The file type can, for example, be used to identify an application on the user device 602 to open or access the file.

Once a file is opened and/or accessed, changes or modifications to the file can be automatically detected and uploaded to the remote device or host from which the file was requested. For example, changes, modifications, or edits to the file accessed using the application can be detected from a file system of the operating system (e.g., via the file system monitoring engine 622). In one embodiment, the file system is monitored through an API of the operating system for file system events. Changes can be detected by querying the file system by the file system monitoring engine 622. The revision detector 621 can also be notified by the by the operating system (e.g., through an API) that the a file system event indicating a file change or modification occurrence has occurred. The notification may be received and/or processed by the notification engine 623.

Upon receiving a notification of file system change indicating file change, edit or modification, or otherwise detecting or determining that the file requested from the remote device or host has been edited or otherwise modified, the revision detector 621 can optionally verify that changes have been made (e.g., using a checksum computed and/or tracked by the checksum tracking engine 624). Regardless of whether a verification of changes is performed, the revisions detector 621 can facilitate the upload or sending of the file with revisions back to the remote device or host from which it was downloaded. In some instances, the modified file is sent back to the remote device or host; in some instances, the detected changes to the file or sent or transmitted back to the device or host.

The revision detector 621 can optionally verify that the version of the file on the remote device or host is less recent than the modified version at the user device 602 or that the file on the remote device has not changed since the modifications performed at the user device 602. In these cases the upload manager 610 can upload or send the file to the remote device or host, and replace the copy stored thereon. The file can in some instances, be automatically deleted from the device after uploading or sending to the host or remote device.

Note that some or all of the processes described above for the request manager 606, editor installer 608, application identifier 611, revision detector 621, and/or application launcher 631 can in part or in whole implemented on the host server (e.g., the host server 500) from which files are requested or downloaded. The processes may be implemented in lieu of or in duplicate with those able to be performed by the components herein described on the client side on the user device 602.

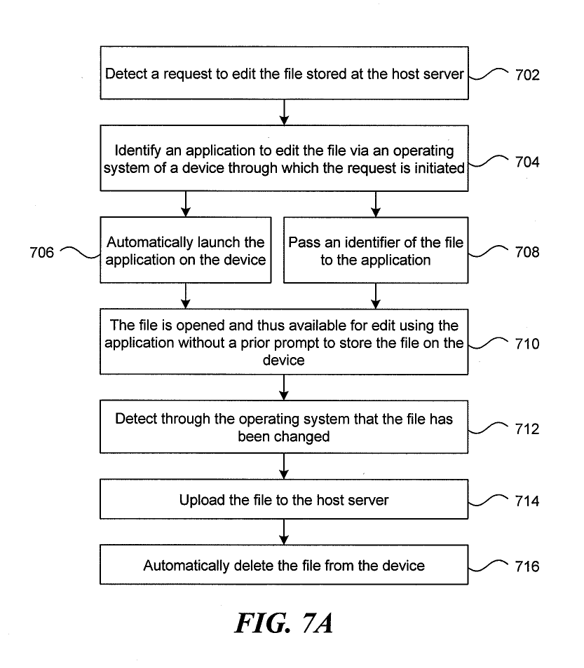

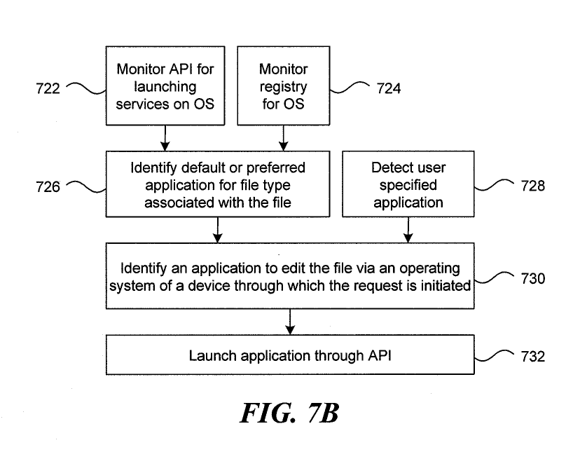

FIG. 7A depicts a flow chart illustrating an example process for networked file editing and version tracking independent of the platform or application on the device used for to access the file.

In process 702, a request to edit the file stored at the host server is detected. The request to edit the file can be initiated at the device, for example, through a web interface to the host server, by a user at the device (e.g., a laptop, computer, or mobile/wireless device (e.g., Smartphone, PDA, mobile phone, tablet, etc.)). In one embodiment, the host server can be a web server hosting an online collaboration environment; wherein, the request is detected through a web interface of the online collaboration environment accessed at the device. The host server can be a host of other types of services allowing remote users to access and/or edit files or other types of work items.

In process 704, an application to edit the file is identified via an operating system of a device through which the request is initiated. In one embodiment, the identification of the application to edit the file occurs transparently to a user who generated the request at the device. This process can also occur without user intervention such that the file automatically opens on the local user device when the user requests to access/edit a file on the host server from their device, regardless of the device platform (e.g., operating system) and/or applications that are available on (e.g., installed on) the device.

In general, the application which is identified is installed on the device or otherwise locally available for use or access on the device. The application may be available (e.g., downloaded) on the device but not yet installed. In addition, the application which is identified may also be accessible to the device over a local network or other networks for use on the device via downloading or application streaming.

In process 706, the application on the device is automatically launched, or in process 708, an identifier of the file is passed to the application. For example, the identifier of the file can be passed to the application when the application is already running on the device. The launching and detection of the application is further illustrated in the example flow of FIG. 7B.

In process 710, the file is opened and thus available for edit using the application without a prior prompt to store the file on the device. While the file or item is locally accessible or otherwise can be locally stored on the user device in local memory, cache, or storage (e.g., hard disk storage) device, the process and step of storage for editing is performed in a manner that does not involve user involvement. For example, the automatic launching of the application can occur without a prior prompt to prompt a user to specify a local directory in which to store the file. The file or item downloaded can be accessed without otherwise acknowledging the user that the file is locally stored and/or acknowledging the user where the file is stored.

In general, the launching of the application is depicted through the user interface as occurring immediately in response to the request without intervening steps. The absence of intervening steps streamlines the process and enhances user experience in accessing or editing files or other work items shared among multiple users (e.g., in a collaboration environment accessed over a network).

In process 712, it is detected through the operating system that the file has been changed. In one embodiment, the changes or edits to the file accessed using the application are detected from a file system of the operating system, for example, through an API of the operating system for file system events.

In process 714, the file is uploaded to the host server. In process 716, the file can be optionally deleted (e.g., automatically) from the device, after the uploading of the file to the host server. In other instances, the file may be retained on the local device.

FIG. 7B depicts a flow chart illustrating examples of platform independent processes for selecting an application on a device for accessing a file.

In process 722, an applications program interface (API) for launching services on the operating system (OS) is monitored. In one embodiment, the application program interface is native to the operating system and can be used for launching services which enables one application to open other applications on the device. This allows interaction with any operating system and allows the identification of any local application which can be used to access, view, or edit the requested file or work item, regardless of the application which was used to create the file, or the platform through which the file was created or last edited, for example.

In general, any native OS API which allows launching of another application can be monitored or queried. APIs that can be used may also provide the ability for an application to open a document or URL in another application, identify or detect a default or preferred application for a given file type or to open a given document or URL, register information in the OS regarding application types and associated file types with which to open a document or file, or detect/extract information used for displaying a file or URL on the display of the device (e.g., icon, display name, kind string, etc.). For example, in MAC OS X, the Launch Services API may be used.

In process 724, the registry for the operating system (OS) is monitored to identify or detect one or more applications. For example, by interacting with the OS (e.g., Windows mobile and desktop platforms) and using registry keys and associated values, one or more default or preferred applications can be identified as suited for a file or file type requested to be opened.

In process 726, a default or preferred application is identified for file type associated with the file. The application can be identified from applications installed on the requesting device or otherwise locally available. Therefore, the application which is identified

In process 728, a user specified application is detected. In process 730, an application to edit the file is identified via an operating system of a device through which the request is initiated. The selected application can be the identified default or preferred application through the operating system or as the application specified by the user. In process 732, the application is launched through the applications program interface (API) and/or the registry of the operating system.

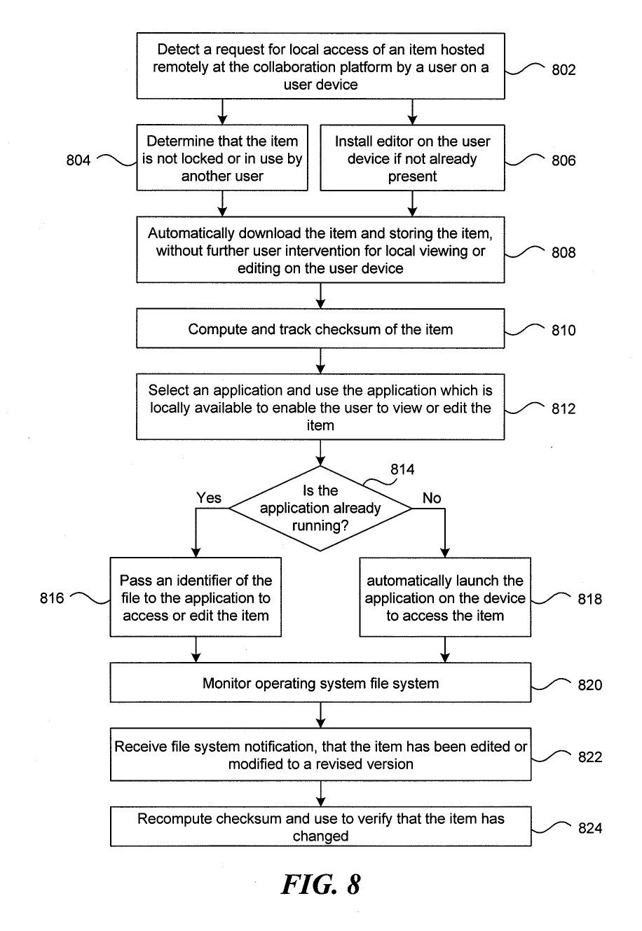

FIG. 8 depicts a flow chart illustrating example platform independent processes for managing file access in a collaboration environment and platform/application independent file editing/access at a user device.

In process 802, a request for local access of an item hosted remotely at the collaboration platform by a user is detected on a user device. In one embodiment, the request is detected through a web interface to the collaboration platform or other services at the device.

In process 804, it is detected that the item is not locked or in use by another user.

In process 806, an editor is installed on the user device if not already present. The editor may be downloaded to the user device first prompting the user or the editor may be automatically downloaded and installed either with or without user intervention. The editor may also be a widget or client running in a web browser which need not be downloaded to the user device for operation.

In process 808, the item is automatically downloaded and stored, without further user intervention for local viewing or editing on the user device. The file can be automatically downloaded, for example, automatically, responsive to verification of authentication credentials received through the web interface verifying that the requesting user is authorized to perform the requested action on the requested file.

In process 810, checksum of the item is computed and/or tracked. The checksum can be computed when first downloaded or stored on the user device, and re-computed periodically or recomputed when notified of a change to the item or change is otherwise detected. The checksum can be used to track the version and revisions to the item.

In process 812, an application which is locally available to enable the user to view or edit the item is selected and used. In process 814, it is determined whether the application is already running on the user device. If so, in process 816, an identifier of the file is passed to the application to access or edit the item.

In one embodiment, the application to edit the file is identified via an operating system of the user device, as described in accordance with the example flow chart of FIG. 7B. By communicating with the operating system (e.g., through a registry or an API of the operating system), this allows any application that's available on the local device to be used through information registered with the operating system, regardless of the origins of the file or work item.

If not, in process 818, the application is automatically launched on the device to access the item.

In process 820, operating system file system is monitored. For example, an API for file system events can be used for monitoring the file system (e.g., in MAC OS X or iOS) or a file system watcher (e.g., Windows Mobile or desktop platforms). In general, any API or classes of an operating system which is able to monitor file systems and detect change in a directory, or file in a directory may be used. These classes or APIs typically generate notifications or raises events when changes are detected and can be used to determine whether a file downloaded has been edited by any application on the user device,

In process 822, file system notification, that the item has been edited or modified to a revised version is received. In process 824, the checksum for the file is recomputed and can be use to verify that the item has changed, before uploading or sending to the host server (e.g., host server of a collaboration platform or other types of services where files and documents or other multimedia files are shared among users).

In one embodiment, if it is detected that a newer version of the item is stored at the collaboration platform, the revised version of the item can be stored as a different copy from the newer version of the item at the collaboration platform. Similarly, if it is detected that the item stored at the collaboration platform is being used or is otherwise locked by another user, the revised version of the item is uploaded to the collaboration platform where it is stored as a different copy from the item.

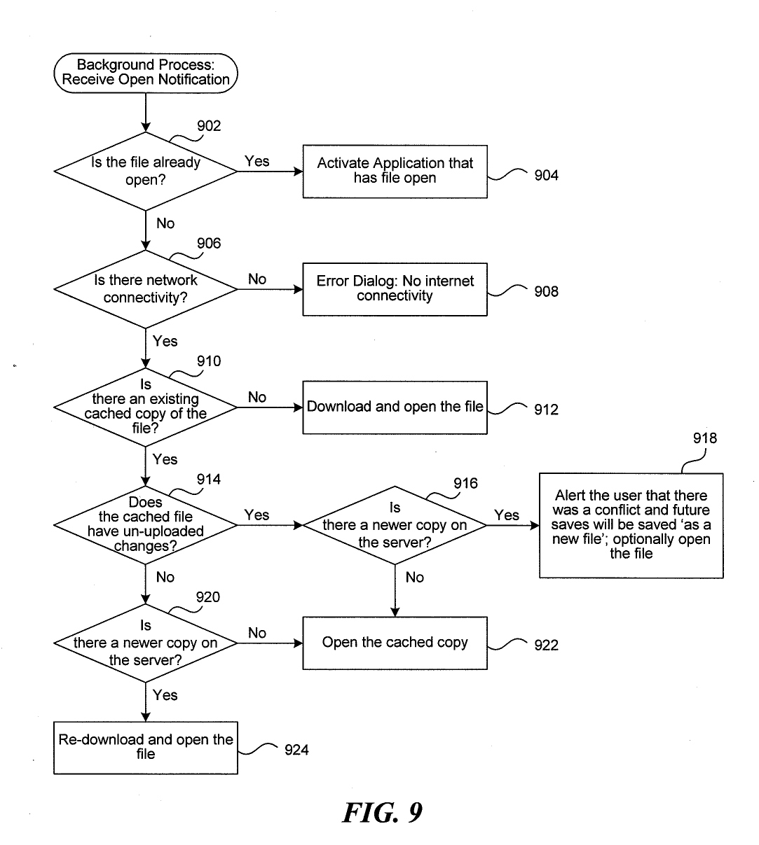

FIG. 9 depicts a flow chart illustrating example process for implementing version tracking and control in response to a request to open or access a file/work item via a collaboration platform.

When a user clicks to edit or access a file through a web browser to the host site of the collaboration platform, the browser collects information including the file ID and/or user authentication information (e.g., via a browser widget or plug-in). The information can then be used (e.g., by various components illustrated in the user device 602 shown in the example of FIG. 6) in opening the file locally.

For example, in step 902, it is determined whether the file is already open. And if so, the application that has the file open is activated or brought to the foreground in step 904. If the file is not yet open at the local device, it can be determined whether there is network connectivity in step 906. If not, an error dialog may be generated to acknowledge the user in step 908. It can also be determined whether a cached copy of the requested file exists in step 910. If not, the file can be downloaded and opened in step 912 in the presence of a network connection. In general, the file can be downloaded and opened for editing without a prior prompt to the user to store the file on the device and/or to select a directory on the device in which to store the file.

If a cached copy exists locally, it is determined whether the cached file has new changes (or changes that have not been uploaded) in process 914. If there are new changes in the locally cached copy, it is determined whether there is a newer copy on the host server (e.g., host server of a collaboration platform) in step 916. If so, the user is alerted that there may be a conflict and future changes can now be saved in a new file in step 918. If the copy on the server is not newer, then the cached copy can be opened on the local device in step 922 for editing by the user.

Similarly, if the cached copy does not have new changes (e.g., un-uploaded changes, or changes not yet reflected), it is determined whether there is a newer version on the host server in step 920. If so, the file is downloaded from the host server and opened in step 924.

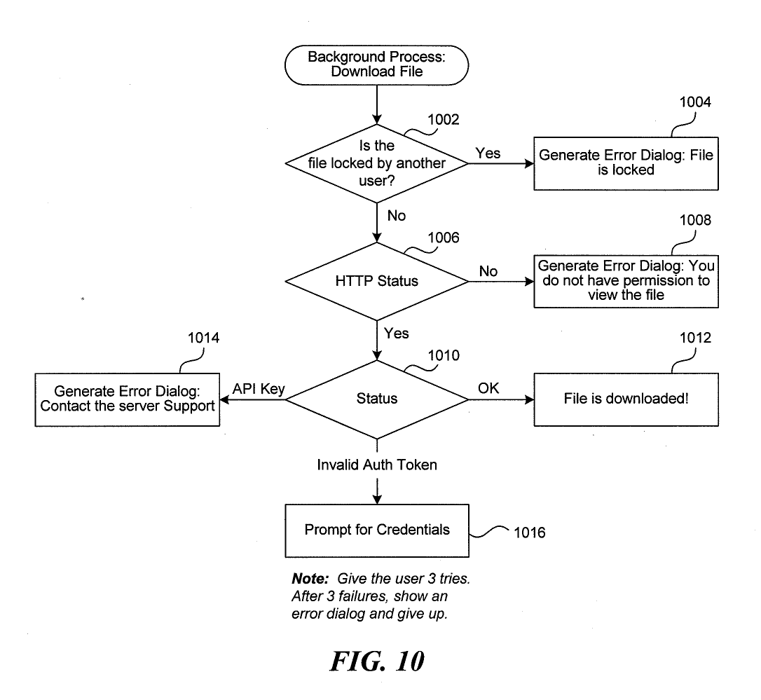

FIG. 10 depicts a flow chart illustrating example process for downloading a file or work item onto a user device for platform or application independent for access or editing that is independent of the device platform or the applications locally available to the user device.

To download a file onto a local user device, it is initially determined (e.g., at the host server) whether the file is locked, for example, as a result of being in use by another user in step 1002. If so, an error message can be generated in step 1004. If not, using the HTTP status, an error may be generated and detected when the requesting user does not have permission to view or access the file. An error dialog can be generated and posted to notify the requesting user. If the HTTP status is OK, the file can be downloaded in step 1012. The status may also return an invalid authentication token and the user may be prompted for credentials in process 1016. The user may be given a certain number of tries to submit valid credentials.

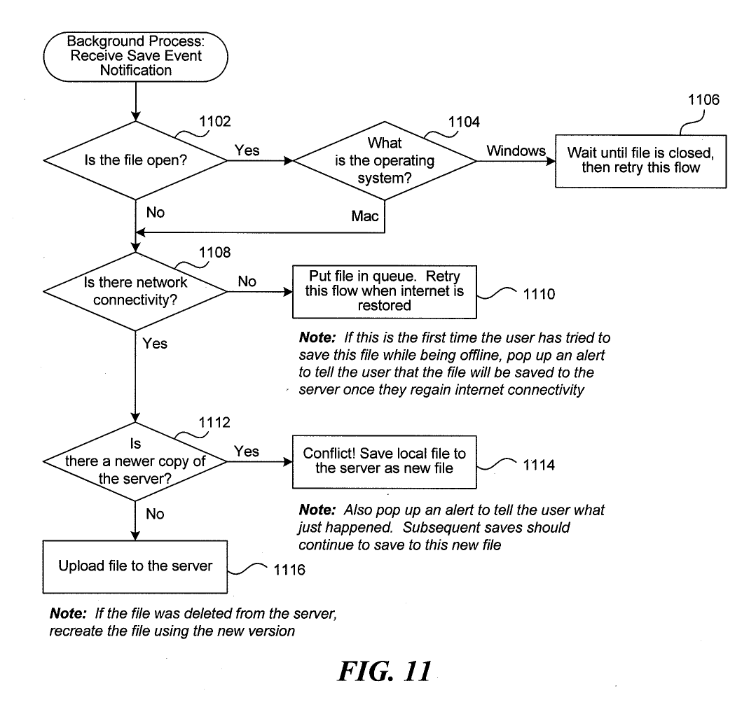

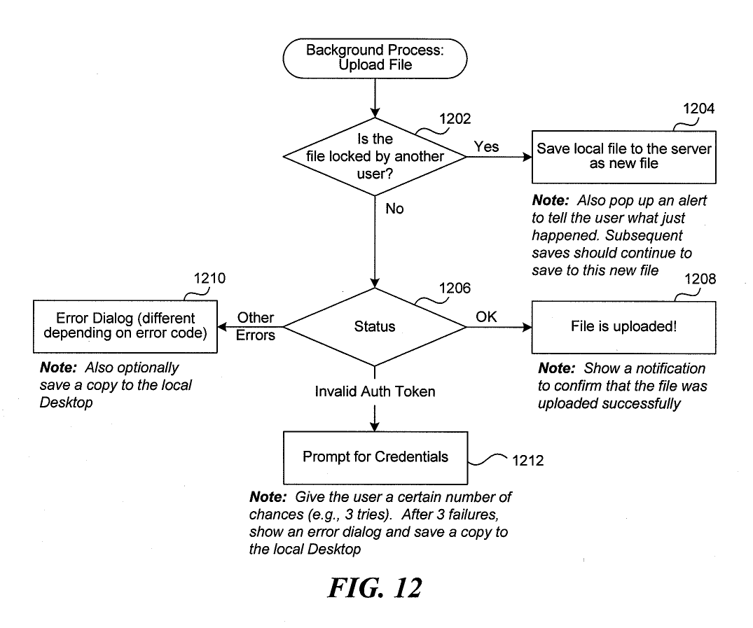

FIG. 11-12 depicts flow charts illustrating example processes for uploading or sending a file/work item that has been remotely edited to a host server from which the file was accessed or downloaded.

When it is detected that a file has been changed or modified, a save event notification is generated at the local device. The save event notification can be generated as a result of receiving a notification from the operating system (e.g., the file system) that the file has been edited and/or has changed. In process 1102, it is determined whether the file which has been edited or changed is open. If so, the operating system of the operating system can be identified in step 1104. For example, if the OS is detected to be windows, then the process waits until the file is closed, in step 1106.

If the operating system is a MAC-based OS, or if the file is not open, then it is determined whether there is network connectivity in step 1108. If not, the file is queued up for retry when network connectivity is available in step 1110. If there is network connection, if is determined whether the version stored on the host server is newer in step 1112. If so, the user is informed of the conflict in step 1114. The local file can be saved or uploaded onto the server as a new file. If the version on the server is not newer, than the local file is uploaded to the server in step 1116.

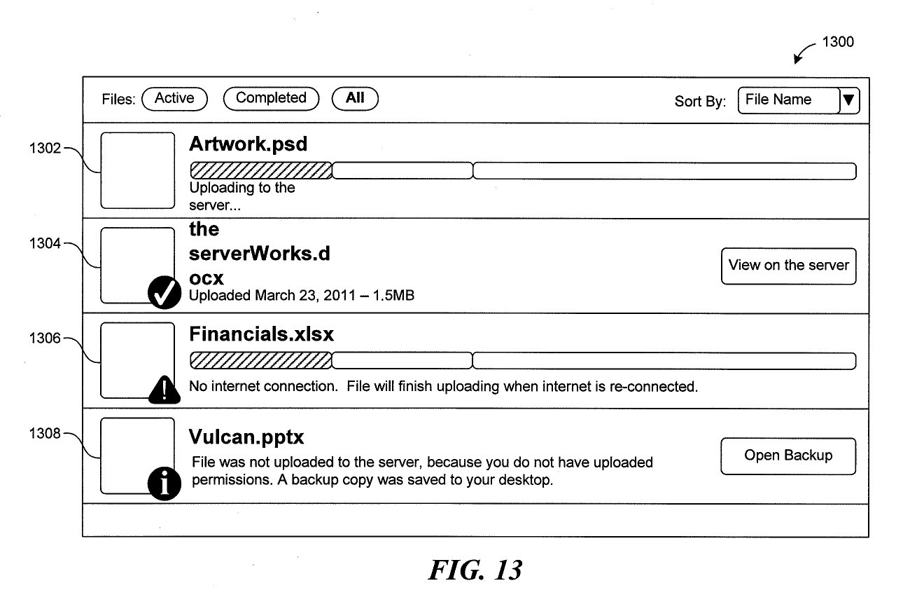

FIG. 13 depicts a screenshot showing an example of a user interface 1300 illustrating processes for uploading or sending a file/work item that has been remotely edited to a host server from which the file was accessed or downloaded.

The user interface 1300 can be accessed via a web browser to a site hosted by the host server of the files (e.g., a host server of a collaboration platform). The statuses of various files 1302, 1304, 1306, and 1308 that have been remotely accessed and/or edited are illustrated. For example, the upload status, and/or version status can be depicted through the user interface 1300.

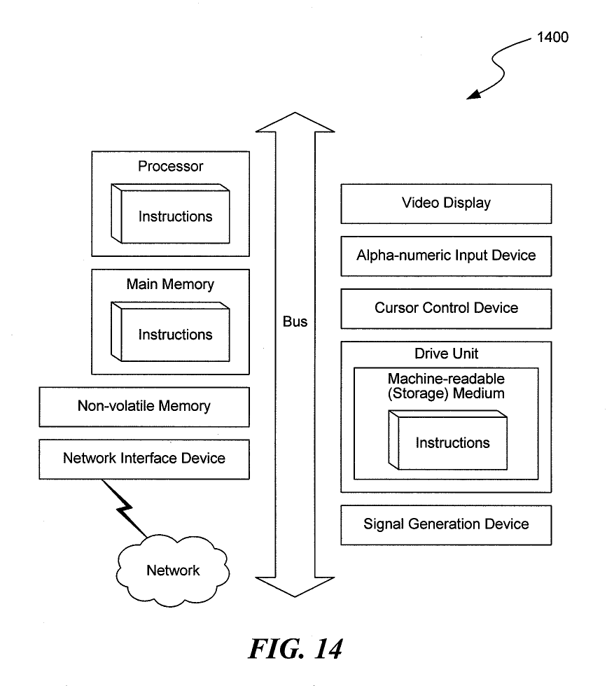

FIG. 14 shows a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 2800 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method for editing a file accessed from a host server, the method, comprising:
responsive to a request to edit the file stored at the host server, identifying an application to edit the file via an operating system of a device through which the request is initiated;
wherein, the application is locally available for use on the device;
automatically launching the application on the device or passing an identifier of the file to the application, such that the file is opened and thus available for edit using the application without a prior prompt to store the file on the device.

2. The method of claim 1, wherein, the automatic launching of the application occurs without the prior prompt to request a user to specify a local directory in which to store the file.

3. The method of claim 1, wherein, the request to edit the file is initiated at the device, through a web interface to the host server, and where the launching of the application is depicted through the user interface as occurring immediately in response to the request without intervening steps.

4. The method of claim 1, wherein, the identification of the application to edit the file occurs transparently to a user who generated the request at the device.

5. The method of claim 1, wherein, the application to edit the file is specified by a user at the device.

6. The method of claim 1, wherein, the application is identified through a registry of the operating system including registry keys and values.

7. The method of claim 1, wherein, the application is identified through an application program interface native to the operating system.

8. The method of claim 1, further comprising, determining, through an application program interface (API) of the operating system, a preferred or default application on the device to access or edit a file type of the file requested to be edited; selecting the application that is launched, as the preferred or default application to handle the file type determined through the API.

9. The method of claim 1, wherein, the application is launched through an application program interface of the operating system.

10. The method of claim 9, wherein, the application program interface is native to the operating system for launching services which enables one application to open other applications on the device.

11. The method of claim 1, wherein, changes or edits to the file accessed using the application are detected from a file system of the operating system.

12. The method of claim 11, wherein, the file system is monitored through an API of the operating system for file system events.

13. The method of claim 1, further comprising, detecting through the operating system that the file has been changed; uploading the file to the host server.

14. The method of claim 13, further comprising, automatically deleting the file from the device after the uploading of the file to the host server.

15. The method of claim 1, wherein, the identifier of the file is passed to the application when the application is already running on the device.

16. The method of claim 1, wherein, the file is stored on the device for editing in a manner that does not involve user involvement.

17. The method of claim 1, wherein, the host server is a web server hosting an online collaboration environment; wherein, the request is detected through a web interface of the online collaboration environment accessed at the device.

18. The method of claim 1, wherein, the application is identified from a set of applications installed on the device.

19. A method to locally edit an item accessed remotely from a collaboration platform, the method, comprising:
in response to determining that the item hosted remotely at the collaboration platform requested for local access by a user on a user device, is not locked or in use by another user,
automatically downloading the item and storing the item, without further user intervention for local viewing or editing on the user device;
using an application which is locally available to enable the user to view or edit the item;
in response to detecting, through an operating system on the user device, that the item has been edited or modified to a revised version, sending the revised version of the item to the collaboration platform.

20. The method of claim 19, further comprising, automatically launching the application on the device to access the item, if the application is not yet running.

21. The method of claim 19, further comprising, passing an identifier of the file to the application to access or edit the item, when the application is already launched on the user device.

22. The method of claim 19, wherein the application to edit the file is identified via an operating system of the user device.

23. The method of claim 19, further comprising, if it is detected that a newer version of the item is stored at the collaboration platform, the revised version of the item is stored as a different copy from the newer version of the item at the collaboration platform.

24. The method of claim 19, further comprising, if it is detected that the item stored at the collaboration platform is being used or is otherwise locked by another user, the revised version of the item is uploaded to the collaboration platform where it is stored as a different copy from the item.

25. The method of claim 19, wherein, the request is detected through a web interface to the collaboration platform at the device and the file is downloaded responsive to verification of authentication credentials received through the web interface.

26. The method of claim 19, wherein, the application is automatically identified through a registry or an API of the operating system.

27. The method of claim 19, further comprising, tracking a checksum for the item to verify that changes have been made before sending or uploading to the collaboration platform.

28. A method for remote access of files stored at a host server by multiple parties, comprising:
providing a file to a first user for access at a first device of the first user's, using a first application which is available to the first user at the first device, the first application being identified through a first operating system of the first device, among applications installed on the first device;
providing the file to a second user for access at a second device of the second user's, using a second application which is available to the second user at the second device, the second application being identified through a second operating system of the second device, among applications installed on the second device.

29. The method of claim 28,
wherein the first application is specified in the first operating system as being default to access the file based on its file type;
wherein, the second application is specified in the second operating system as being default to access the file based on its file type.

30. The method of claim 28, further comprising:
prior to providing the file to the first and second users, authenticating, at the host server, a first and second user request to edit the file through credentials provided via a web interface to services hosted by the host server;
providing the file to the first and second users and enabling the file for editing at either the first device or the second device when the file is not locked or in use by the other party.

31. The method of claim 28, further comprising:
storing updated versions of the file received from the first and second devices, at the host server in a manner that resolves conflicting changes to the file.

32. A system to enable remote editing of edit an item accessed remotely from a collaboration platform, the method, comprising:
means for, detecting a request to edit the file stored at the host server;
means for, identifying an application to edit the file via an operating system of a device through which the request is initiated;
wherein, the application is locally available for use on the device;
means for, automatically accessing the application, such that the file is opened and thus available for edit using the application without a prior prompt to store the file on the device.

33. The system of claim 32, further comprising: means for, automatically launching the application identified via the operating system.

34. The system of claim 32, further comprising: means for, passing an identifier of the file to the application to use the application identified through the operating system to access the file.

35. The system of claim 32, further comprising,
means for, determining, through an application program interface (API) of the operating system, a preferred or default application on the device to access or edit a file type of the file requested to be edited;
means for, selecting the application that is launched, as the preferred or default application to handle the file type determined through the API.

36. The system of claim 32, further comprising,
means for, monitoring a file system of the operating system for changes or edits to the file accessed using the application.

37. The method of claim 36, further comprising, means for, monitoring, the file system through an API of the operating system for file system events.
